(19) United States
(12) Patent Application Publication
(10) Pub. No.: US 2024/0079676 A1
(43) Pub. Date: Mar. 7, 2024

(54) SUPPORT STRUCTURE FOR A NUMBER OF BATTERY MODULES, AND BATTERY MODULE ASSEMBLY

(71) Applicant: Witzenmann GmbH, Prforzheim (DE)

(72) Inventors: David EHRENBERGER, Königsbach-Stein (DE); Alexander LEIPPI, Pforzheim (DE)

(21) Appl. No.: 18/459,579

(22) Filed: Sep. 1, 2023

(30) Foreign Application Priority Data
Sep. 2, 2022 (DE) 102022122309.4

(51) Int. Cl. H01M 10/656; H01M 10/613; H01M 10/6554; H01M 50/209

(52) U.S. Cl. CPC H01M 10/656; H01M 10/613; H01M 10/6554; H01M 50/209

(57) ABSTRACT

A support structure (7) for a number of battery modules (2), having: a plurality of support elements (7a, 7b), which support elements (7a, 7b) are disposed so as to be mutually spaced apart and therebetween configure a number of compartments (7c), which compartments (7c) are specified to receive in each case one battery module (2); which support structure (7) is distinguished by the fact that at least a number of the support elements (7a) are configured as fluid line elements or comprise fluid line elements, which fluid line elements extend into the respective region of the compartments (7c), and by way of which fluid line elements a temperature-control fluid for the battery modules (2) is able to be supplied into the region of the compartments (7c) and is able to be discharged again from there.

### CROSS-REFERENCE TO RELATED APPLICATIONS

This application claims priority to German Patent Application No. 10 2022 122 309.4, filed Sep. 2, 2022, which is incorporated herein by reference as if fully set forth.

### TECHNICAL FIELD

The invention relates to a support structure for a number of battery modules, having: a plurality of support elements, which support elements are disposed so as to be mutually spaced apart and therebetween configure a number of compartments, which compartments are specified to receive in each case one battery module.

The invention moreover relates to a battery module assembly, comprising a support structure according to the invention and a number of battery modules which are received in compartments of the support structure.

### BACKGROUND

Battery modules, in particular lithium-based battery modules, nowadays are increasingly used for the (temporary) storage of electric power and for supplying installations with electric power. For this purpose, a multiplicity of battery modules are usually wired up and accommodated in special rack systems in a common casing, e.g. in the manner of a (shipping) container.

During operation, battery modules of this type generate a considerable amount of waste heat so that temperature-controlling (especially cooling) is typically provided, in particular fluid-based cooling in which the individual battery cells are internally passed through by a flow of cooling fluid. It is disadvantageous herein that a corresponding fluid cooling system has to be provided in addition to the rack system mentioned, as a result of which the entire construction becomes complex and expensive and requires an enlarged installation space. Additional material is used in the process. In order to guarantee ease of assembling and ready access for maintenance, particular constructive measures are required here, which likewise have a negative influence in terms of installation space and system costs.

### SUMMARY

There is the need for a support system, or a support structure, for battery modules and for a corresponding battery module assembly, which enables temperature-controlling of the battery modules without being subject to the above-mentioned disadvantages in terms of the required installation space, material consumption, costs, complexity and accessibility.

This object is achieved according to the invention by a support structure having one or more of the features disclosed herein, and by a battery module assembly having one or more of the features disclosed herein.

Advantageous refinements of the concept according to the invention are defined below and in the claims.

Provided according to the invention is a support structure for a number of battery modules, having: a plurality of support elements, which support elements are disposed so as to be mutually spaced apart and therebetween configure a number of compartments, which compartments are specified to receive in each case one battery module; wherein at least a number of the support elements (hereunder also referred to as “fluid-conducting support elements”) are configured as fluid line elements or comprise fluid line elements, which fluid line elements extend into the respective region of the compartments and by way of which fluid line elements a temperature-control fluid for the battery modules is able to be supplied into the region of the compartments and is able to be discharged again from there.

This advantageously relates predominantly to vertical support elements which configure a type of rack structure and therebetween receive horizontal support elements in the manner of shelves or the like in which the battery modules can be disposed between the vertical support elements. The vertical and horizontal support elements mentioned define (in particular cuboid) compartments or receptacles for the battery modules, as is known from conventional rack systems or racks.

The invention now provides that at least some of the support elements assume a dual function, specifically as a static support part and at the same time as a fluid-guiding line part, whereby no fundamental differences are to be made between vertical and horizontal support elements. This is thus a functional integration of the support function of the battery module rack and the fluid guidance/distribution of a cooling medium for the thermal management of the battery modules in a system.

According to the invention, a battery module assembly comprising the support structure according to the invention and the number of battery modules which are received in compartments of the support structure is distinguished by the fact that the battery modules (or at least some of the battery modules) have an internal temperature-control circuit and are fluidically connected to the fluid-conducting support elements.

The advantageous functional integration already mentioned results in this way.

In other words, it is proposed that a battery cooling pipe (BCP) is constructed, which in addition to the function of fluid guidance for a temperature-control medium represents the function of a support structure for the battery modules.

The BCP here is preferably configured in such a manner that at least part of the support structure, i.e. a number of the support elements, which support elements form the support structure, is embodied so as to be closed in the manner of a pipeline in order to implement the function of fluid guidance. The connection to the remaining support structure, i.e. to the remaining support elements, can be established so as to be releasable by a screw connection, or preferably so as to be non-releasable by way of a forming connection such as, for example, riveting, and most preferably in a materially integral manner by adhesive bonding, soldering/brazing or welding.

The fluid-guiding support structure (i.e. the fluid-guiding support elements) here can be utilized for distributing a mass flow of the temperature-control medium to the consumers (thus the battery modules), for example in that corresponding branches are established by attaching in a targeted manner necks or the like.

A corresponding variant of the support structure according to the invention has support elements which are configured to be fluid-guiding and have a plurality of hollow chambers. Two hollow chambers are preferably used in order to be able to implement the forward flow and the return flow of the temperature-control medium in a single support element. A particularly advantageous triple-chamber system can include, for example, a forward flow, a return flow, and a further chamber for an extinguishing agent and/or purge gas. The extinguishing agent can be released in the event of a defect.

Further chambers for routing cables or for communication and for directing flue gas can optionally be provided and correspondingly utilized.

In order for the fluid-guiding support elements (abbr.: FSE) to be connected, the latter can be mutually braced in a releasable manner or be adhesively bonded in a materially integral manner, soldered/brazed or welded, preferably with the intervention of at least one sealing element (for example an O-ring).

In a further variant, the FSEs can be connected and wired by way of node elements, which node elements are preferably produced by primary shaping, for example as castings. These node elements can provide additional functions such as, for example, ventilation valves, sample recovery, measuring elements/sensors, infeed and outfeed points, or fixing points.

The connection between the FSEs and the node elements can be embodied so as to be non-releasably materially integral or releasable, depending on the respective requirement, so as to take into account the desired ease of assembling.

The FSEs can also be utilized for exchanging heat with the environment. Cooling fins or comparable structures can be present to this end.

The branches mentioned on the FSEs are preferably embodied in such a manner that fluidic contact is generated directly during assembling (preferably by inserting) of the battery modules into the support structure or into the respective compartments. Securing the connection can take place by way of the battery modules being held in position within the support structure, as is typically provided anyway. Separate additional securing elements are thus not necessary.

A further variant of the invention provides that the (rack) compartments are equipped with baseplates and integrated baseplate cooling, in particular by means of the temperature-control fluid, the batteries being able to be attached directly in a thermally conducting manner to said baseplates. The baseplate cooling here can be linked directly in a materially integral manner, preferably without any additional sealing element, to a supply and a discharge of temperature-control fluid to and from the FSEs. The direct thermal conduction between baseplates and battery modules here can be implemented by way of a thermal paste or by mechanical bracing.

A further variant of design embodiment provides that the (rack compartment) baseplates are equipped with thermal pipes, which thermal pipes preferably protrude into the FSEs and therein dissipate heat. An additional fluid contact can be dispensed with here.

If (additional) vertical cooling plates are linked to the FSEs, the battery modules can (also) have heat removed from them laterally once said battery modules have been thermally linked to the cooling plates (for example, by means of thermal paste and/or mechanical bracing).

This variant can be particularly advantageous if the battery modules have an internal immersion cooling circuit in order to transport the heat created to an external surface from which said heat can be better dissipated. Installation space is saved here, and a more homogenous distribution of temperature in the system is achieved.

The following design embodiments have proven particularly advantageous:

A first refinement of the support structure according to the invention provides that at least a number of the support elements per se are circumferentially closed and configured as fluid line elements. A particular extensive functional integration is achieved as a result.

A second refinement of the support structure according to the invention provides that the fluid-conducting support elements are releasably connected, in particular by a screw connection, or non-releasably connected, in particular by rivets or by a materially integral connection, for example by soldering/brazing or welding, to a remaining support structure that is not fluid-conducting. A stable support structure which is upgradable in an arbitrary manner is achieved in this way.

A third refinement of the support structure according to the invention provides that at least a number of the fluid-conducting support elements have at least two fluidically isolated chambers or fluid line elements. In this way, a fluid forward flow as well as a fluid return flow can be configured within the support elements, this further reducing the number of required components.

Another refinement of the support structure according to the invention provides that at least a number of the fluid-conducting support elements have at least three fluidically isolated chambers or fluid line elements. Further functions can be integrated in the FSEs as a result.

As has already been mentioned, it can be provided, for example, that at least a number of the fluid-conducting support elements additionally have chambers for routing cables or for communication or for directing flue gas.

Yet another refinement of the support structure according to the invention provides that the fluid-conducting support elements by way of at least one sealing element are mutually braced releasably in pairs, preferably adhesively bonded in a materially integral manner, soldered/brazed or welded. In this way, support structures of any arbitrary size can be constructed, depending on the requirement.

Yet another refinement of the support structure according to the invention provides that the fluid-conducting support elements are connected and wired by way of node elements, which node elements are preferably produced by primary shaping. This has already been discussed in detail above.

The node elements can preferably have additional functions such as ventilation valves, sample recovery, measuring elements/sensors, infeed and outfeed points, or fixing points; this has also already been discussed. Added value in functional terms can be achieved as a result.

If correspondingly refined, a respective connection between the fluid-conducting support elements and the node elements can be embodied so as to be non-releasable, preferably in a materially integral manner, or releasable in order to guarantee modularity to the greatest extent.

In a refinement of the support structure according to the invention it can also be provided that fluidic connector structures for the battery modules are present in the region of the compartments, which connector structures are preferably configured to be flexible, most preferably in the form of corrugated hose portions or bellows, which are accessible in an insertion direction when inserting the battery modules into the compartments, so as to establish a fluidic connection between battery modules and fluid-conducting support elements when inserting the battery modules. As a result, a type of “plug-and-play” connection between the battery modules and the support structure can be established, which is particularly easy to implement. In an analogous manner, an associated electrical connection for the battery modules and/or a data connection (e.g. to the BMS—battery management system) can be implemented.

A corresponding refinement of the battery module assembly according to the invention includes that the fluidic connector structures for the battery modules in the region of the compartments in the insertion direction are co-aligned with at least partially complementary, in particular rigid, connector structures of the battery modules so as to establish a fluidic connection between battery modules and fluid-conducting support elements in a quasi-automatic manner when inserting the battery modules, whereby the complementary connector structures of the battery modules preferably engage in the connector structures of the support structure, or vice versa, preferably with the intervention of at least one sealing element, which sealing element is preferably disposed on the connector structures of the battery modules.

In a refinement of the support structure according to the invention it can also be provided that this support structure has a (position-)securing installation for the battery modules in the region of the compartments, which securing installation is at the same time configured to secure the fluidic connection. An improved functional integration is also achieved as a result.

In a refinement of the support structure according to the invention it can moreover be provided that one baseplate is in each case present in the region of at least some compartments, which baseplate is specified to contact in a thermally conducting manner at least one battery module, and which baseplate is fluidically connected to at least one fluid-conducting support element. The advantages of this design embodiment have already been pointed out further above.

In a refinement of the support structure according to the invention it can furthermore be provided that one baseplate is in each case present in the region of at least some compartments, which baseplate is specified to contact in a thermally conducting manner at least one battery module, and which baseplate by way of at least one thermal pipe is connected to at least one fluid-conducting support element. The advantages of this design embodiment have also already been pointed out further above.

In a refinement of the support structure according to the invention it can finally be provided that at least one lateral cooling plate is in each case present in the region of at least some compartments, which cooling plate is specified to contact in a thermally conducting manner at least one battery module. The advantages of this design embodiment have likewise already been pointed out further above.

### BRIEF DESCRIPTION OF THE DRAWINGS

Further characteristics and advantages of the invention are derived from the exemplary embodiments described below by means of the drawing in which:

FIG. 1 schematically shows a battery module assembly according to the invention;

FIG. 2 schematically shows a battery module assembly according to the invention with a support structure according to the invention;

FIG. 3 shows a detail in a battery module assembly or support structure according to the invention, respectively;

FIG. 4 shows a further detail in a battery module assembly or support structure according to the invention, respectively; and

FIG. 5 shows yet a further detail in a battery module assembly or support structure according to the invention, respectively.

### DETAILED DESCRIPTION

The same reference signs refer to identical or at least functionally equivalent elements in all figures.

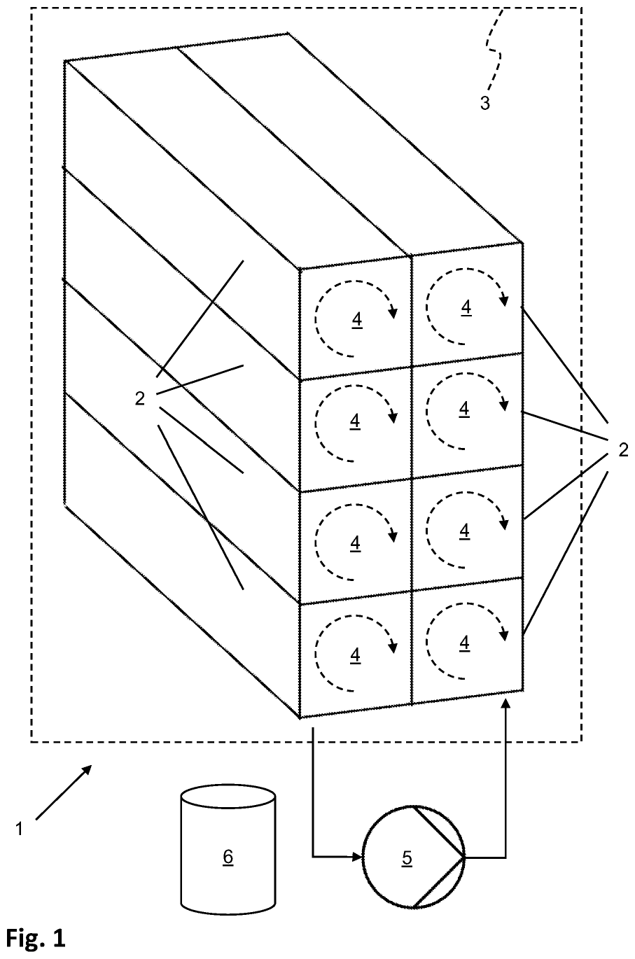

Shown in FIG. 1, denoted by the reference sign 1, is a generic battery module assembly which comprises a plurality of battery modules 2 which are placed so as to be stacked in an arrangement of (horizontal) rows and (vertical) columns. The battery modules 2 are typically situated within a suitable casing 3 which is only symbolically illustrated by dashed lines in FIG. 1.

According to FIG. 1, the battery modules 2 are in each case equipped with an internal temperature-control circuit for a temperature-control fluid, which temperature-control circuit is symbolically illustrated and denoted by the reference sign 4. A conveying means 5 for supplying the temperature-control fluid (temperature-control medium) to the individual battery modules 2 and subsequently (upon heat transfer) discharging it from the latter again is provided so as to be fluidically operatively connected to the internal temperature-control circuits 4. Reference sign 6 denotes a tank or storage means for the temperature-control fluid. The conveying means 5 and the storage means 6 form an external temperature-control circuit for the temperature-control fluid, which external temperature-control circuit for reasons of clarity is not illustrated again in the further figures. The external temperature-control circuit does not mandatorily have to be disposed outside the casing 3.

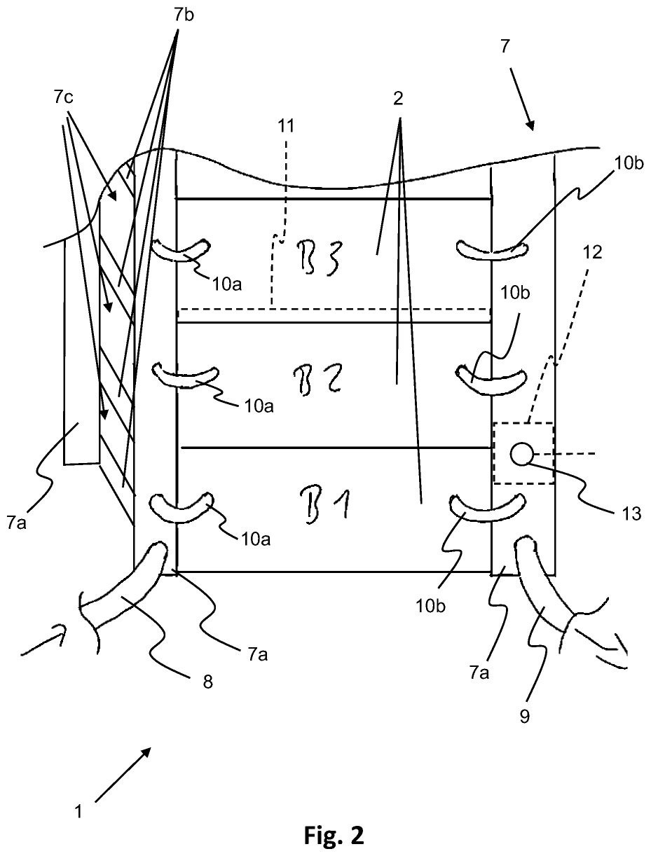

FIG. 2 shows a somewhat more detailed illustration of the battery module assembly 1, or of a comparable assembly, in which the battery modules 2 are disposed in the manner of a rack or shelf unit within a support structure 7, respectively. Such a support structure 7 is in principle also present in the battery module assembly 1 according to FIG. 1 but is not illustrated there for reasons of clarity.

As can be derived from FIG. 2, the support structure 7 first comprises a row of vertical support elements 7a (posts) which at least in part are connected to one another by horizontal support elements 7b in order to achieve the rack or shelf structure mentioned. In this way, the vertical support elements 7a and the horizontal support elements 7b define cuboid receptacles or compartments 7c for introducing or inserting the battery modules 2 as illustrated, respectively. The support structure 7 in terms of a number and/or geometric arrangement of the battery modules 2 and in terms of shape and/or size is not limited to the design embodiment illustrated in FIGS. 1 and 2.

As can be derived in particular from FIG. 2, at least the two front vertical support elements 7a function not only as structural elements but additionally also as line elements (FSE) for the temperature-control fluid (cf. FIG. 1). To this end, the front left support element 7a, for example, has a connector 8 for introducing the temperature-control fluid, while the front right support element 7a, for example, has a connector 9 for discharging the temperature-control fluid. For this purpose, the front left support element 7a per se can be configured as a fluid line element, thus be circumferentially closed in the manner of a pipe, or it can internally comprise an additional fluid line element. Said front left support element 7a preferably functions as a distributor element from which the temperature-control fluid can be supplied to the individual battery modules 2 (also denoted as B1, B2, B3, . . . in FIG. 2). To this end, in the design embodiment in FIG. 2, fluid-conducting connection elements 10a, e.g. in the form of corrugated hose portions, are provided between the front left support element 7a and the individual battery modules 2, which connection elements 10a are preferably fluidically operatively connected to the respective temperature-control circuits 4 (cf. FIG. 1) of the battery modules 2.

The front right support element 7a is preferably configured in an analogous manner and serves for collecting and discharging the temperature-control fluid from the individual battery modules 2. For this purpose, fluid-conducting connection elements 10b, e.g. in the form of corrugated hose portions, are provided between the front right support element 7a and the individual battery modules 2, which connection elements 10b are preferably likewise fluidically operatively connected to the respective temperature-control circuits 4 (cf. FIG. 1) of the battery modules.

Not all vertical support elements 7a have to be configured as fluid-conducting support elements. According to the design embodiment in FIG. 2, for example, only the two front vertical support elements 7a are configured as fluid-conducting support elements. The two rear vertical support elements 7a, of which only one can be seen for illustrative reasons in FIG. 2, do not have to be configured to be fluid-conducting but may represent simple support posts.

By way of example, a baseplate 11 is also plotted between the battery modules B2 and B3 in FIG. 2; corresponding baseplates 11 can also be provided between the other battery modules 2. In a corresponding thermally conducting connection between the baseplate 11 and the adjacent battery modules B2 and B3 (for example while using thermal paste), additional temperature-controlling of the battery modules can take place. To this end, the baseplate 11 can also be connected in a fluid-conducting manner to the temperature-control circuit of the battery module assembly 1, this not being explicitly illustrated in FIG. 2. Alternatively or additionally, there is also the possibility of connecting the baseplate 11 to the adjacent battery modules B2 and/or B3 in a thermally conducting manner by way of thermal pipes or the like, so as to enable the discharge of heat. This is also not explicitly illustrated in FIG. 2.

Reference sign 12 denotes a node element which is illustrated by way of example and can be used for (releasably) connecting individual, comparatively short portions of the vertical support elements 7a. Node elements 12 of this type are preferably produced by primary shaping, thus in a casting process, for example, and comprise additional functional elements such as the sensor illustrated by way of example and denoted by the reference sign 13 in FIG. 2, which sensor may be a temperature sensor, without being limited thereto.

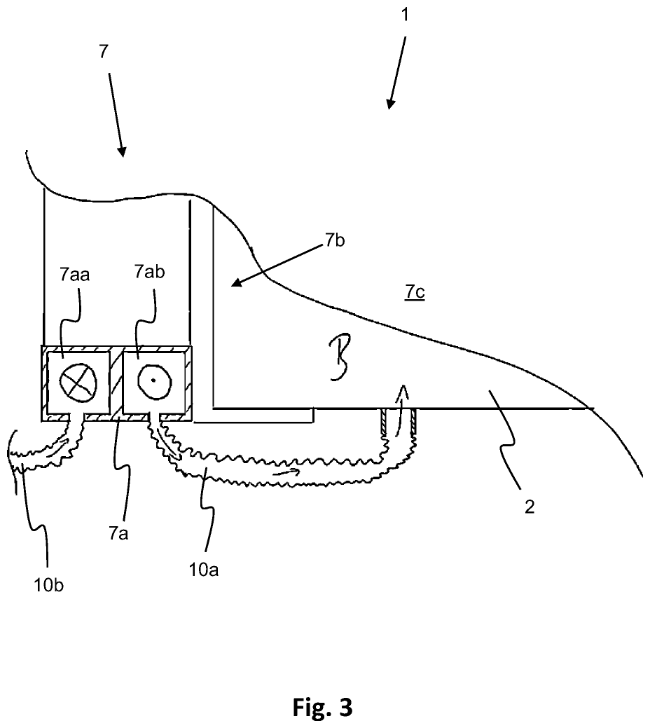

FIG. 3 shows a partial, horizontal section through a similar battery module assembly 1 as is illustrated in FIG. 2. The substantial difference lies in that the vertical support element 7a presently has two (hollow) chambers 7aa, 7ab of which the one (left) chamber 7aa serves for discharging heated temperature-control fluid, while the other (right) chamber 7ab is specified to supply fresh temperature-control fluid. In this way, one and the same support element 7a can be used for supplying as well as for discharging temperature-control fluid.

In order to ideally prevent any thermal short-circuit, the cross section of the element 7a can be embodied in such a manner that this results in an ideally minor heat transfer surface between the forward flow and the return flow. Additionally or alternatively, a thermally insulating element (not shown) can be incorporated between the chambers 7aa, 7ab.

Furthermore, it is also possible for a liner (preferably made of plastics material) to be placed in the support element 7a (not shown), or for the support element 7a per se to be produced from a thermally insulating material. The support element 7a is preferably an extruded profile of plastics material, most preferably a pultruded profile having optionally included (foam) cores for increasing the area moment of inertia and for improving the thermal insulation.

The invention is in no way limited to support elements 7a with one or two (hollow) chambers; of course, even further chambers may be provided, for example in order to route cables and/or direct extinguishing agents or similar substances. The extinguishing agent can also be stored in a pressurized manner in the profile (support element 7a) so as to be delivered by way of a suitable device, such as a breaker plate, in the event of a fire.

Here and in all other design embodiments, the horizontal support elements 7b can likewise in principle also function as line elements for the temperature-control fluid, this however not being illustrated in the figures.

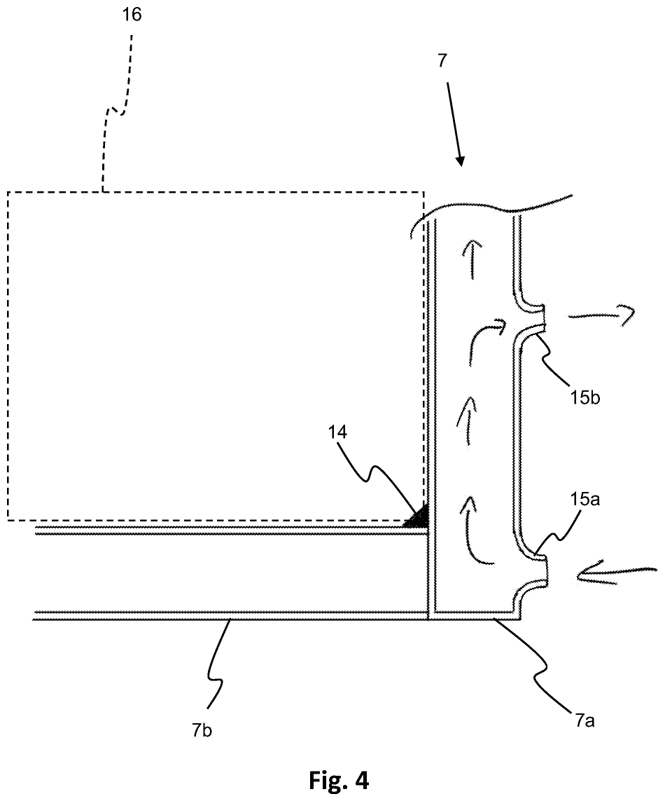

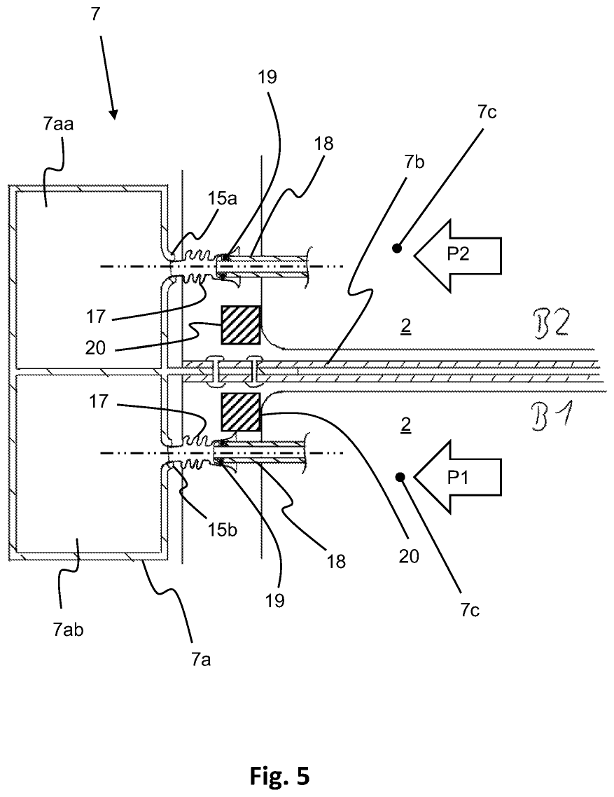

Illustrated in FIG. 4 is a partial vertical section through the support structure 7. A horizontal support element 7b, which at the reference sign 14 is connected in a materially integral manner (adhesively bonded or welded) to a vertical support element 7a, can be seen. Deviating therefrom, the connection can in particular also be embodied so as to be releasable (cf. FIG. 5). The support element 7a is again configured as a line element for a temperature-control fluid, which temperature-control fluid is directed into the support element 7a at the neck 15a and is guided in the support element 7a, for example up to the further neck 15b, from where said temperature-control fluid makes its way to a battery module not shown here (cf. for example reference sign 10a in FIG. 2).

FIG. 4 moreover shows (in dashed lines) a lateral cooling plate 16 which is preferably laterally brought into thermally conducting contact with a battery module received in the support structure 7 (not shown here) so as to achieve additional temperature-controlling of the battery module, in particular while using thermal paste. The lateral cooling plate 16 can be connected in a fluid-conducting manner to the temperature-control circuit, i.e. to the FSE 7a. In a manner analogous to the baseplate 11 according to FIG. 2, the use of thermal pipes or the like can be additionally or alternatively considered. For reasons of clarity, this is in each case not illustrated in FIG. 4. Of course, corresponding cooling plates 16 can be used on both sides of the support structure 7.

Finally, FIG. 5 shows a sectional view similar to that of FIG. 3. Here too, the vertical support element 7a is equipped with two chambers 7aa, 7ab which are in each case specified to direct the temperature-control fluid, presently in each case to feed in fresh temperature-control fluid. A flexible connector part 17 in the manner of a corrugated hose portion with a flared free end is disposed on each of the chambers 7aa, 7ab in the region of a respective neck 15a, 15b, which connector part 17 protrudes in the direction of an associated receptacle (compartment) 7c for a battery module 2 and forms a corresponding connector structure. A partially complementary connector structure in the form of a rigid pipeline portion 18 is provided on the respective battery module 2 or B1, B2, respectively, which rigid pipeline portion 18 on the free end thereof has a sealing means 19, for example an O-ring, and is operatively connected in a fluid-conducting manner to the internal temperature-control circuit (cf. reference sign 4 in FIG. 1) of the associated battery module 2. When the battery modules 2 or B1, B2, respectively, are inserted into the associated receptacles or compartments 7c in the direction of the arrows P1, P2, the relative dimensions of the battery modules 2 or B1, B2, respectively, on the one hand, and of the compartments 7c, on the other hand, are preferably chosen such that the connector structures mentioned are co-aligned along the chain-dotted lines in FIG. 5, such that a fluidic connection between the support element 7a, on the one hand, and the respective battery module 2 or B1, B2 (thus the internal temperature-control circuit), respectively, is automatically established when inserting the battery modules 2 or B1, B2, respectively. In order for the temperature-control fluid to be discharged from the battery modules 2, there are preferably corresponding connector structures which however are not explicitly illustrated in FIG. 5.

Reference sign 20 purely schematically shows a detent and securing installation for the respective battery module 2 or B1, B2, respectively, which installation ensures that the respective battery module 2 or B1, B2, respectively, is securely held in its receptacle (the compartment 7c), as a result of which the fluid-conducting connection in the region of the connector structures mentioned is also secured at the same time. Moreover, the battery modules 2 or B1, B2, respectively, may not unintentionally be inserted too far according to arrows P1, P2, which could otherwise lead to damage, especially to the connector parts 17. Such a securing installation can in principle be used in all design embodiments of the present invention. Said securing installation is not limited to the design embodiment according to FIG. 5.

1. A support structure (7) for a number of battery modules (2), the support structure comprising:
a plurality of support elements (7a, 7b) disposed so as to be mutually spaced apart and therebetween configure a number of compartments (7c), said compartments (7c) are defined to receive in each case one of the battery modules (2); and
at least a plurality of the support elements (7a) are configured as fluid line elements or comprise fluid line elements, said fluid line elements extend into a respective region of the compartments (7c), and the fluid line elements are adapted to receive a temperature-control fluid for the battery modules (2) that is suppliable into the region of the compartments (7c) and is dischargeable therefrom.

2. The support structure (7) as claimed in claim 1, wherein
the plurality of the support elements (7a) per se are circumferentially closed and configured as the fluid line elements.

3. The support structure (7) as claimed in claim 1, wherein
the support elements (7a) that are fluid-conducting are connected to a remaining support structure (7) that is not fluid-conducting.

4. The support structure (7) as claimed in claim 1, wherein
at least some of the plurality of the support elements (7a) that are fluid-conducting have at least two fluidically isolated chambers (7aa, 7ab) or the fluid line elements.

5. The support structure (7) as claimed in claim 1, wherein
at least some of the plurality of the support elements (7a) that are fluid conducting have at least three fluidically isolated chambers (7aa, 7ab) or the fluid line elements.

6. The support structure (7) as claimed in claim 1, wherein
a plurality of the support elements (7a) that are fluid-conducting have additional chambers for routing cables or for communication or for directing flue gas.

7. The support structure (7) as claimed in claim 1, wherein
the support elements (7a) that are fluid-conducting are mutually braced by at least one sealing element releasably in pairs.

8. The support structure (7) as claimed in claim 1, wherein
the fluid-conducting support elements (7a) that are fluid-conducting are connected and wired via node elements (12).

9. The support structure (7) as claimed in claim 8, wherein
the node elements (12) include at least one of ventilation valves, sample recovery, measuring elements/sensors (13), infeed and outfeed points, or fixing points.

10. The support structure (7) as claimed in claim 8, wherein
a respective connection between the support elements (7a) that are fluid-conducting and the node elements (12) is non-releasable.

11. The support structure (7) as claimed in claim 1, further comprising
fluidic connector structures (17) for the battery modules (2) located in the region of the compartments, said connector structures (17) are flexible and are accessible in an insertion direction (P1, P2) when inserting the battery modules (2) into the compartments (7c), so as to establish a fluidic connection between battery modules (2) and fluid-conducting support elements (7a) when inserting the battery modules (2).

12. The support structure (7) as claimed in claim 11, further comprising
a securing installation (20) for the battery modules (2) in the region of the compartments (7c), said securing installation (20) being further configured to secure the fluidic connection.

13. The support structure (7) as claimed in claim 1, further comprising
baseplates (11) located respectively in at least some of the compartments (7c), said baseplates (11) contact in a thermally conducting manner the respective battery module (2), and said baseplates (11) being fluidically connected to at least one fluid-conducting support element.

14. The support structure (7) as claimed in claim 1, further comprising
baseplates (11) located respectively in at least some of the compartments (7c), said baseplates (11) contact in a thermally conducting manner the respective battery module (2), and said baseplates (11) being connected via at least one thermal pipe to at least one of the support elements (7a) that are fluid-conducting.

15. The support structure (7) as claimed in claim 1, further comprising
at least one lateral cooling plate (16) located in the region of at least some of the compartments (7c), said cooling plate (16) is adapted to contact the battery module (2) in a thermally conducting manner.

16. A battery module assembly (1) comprising the support structure (7) as claimed in claim 1, and a plurality of battery modules (2) which are received in compartments (7c) of the support structure (7), the battery modules (2) have an internal temperature-control circuit (4) and are fluidically connected to the fluid-conducting support elements (7a).

17. The battery module assembly (1) as claimed in claim 16, further comprising fluidic connector structures (17) for the battery modules (2) located in the region of the compartments, said connector structures (17) are flexible and are accessible in an insertion direction (P1, P2) when inserting the battery modules (2) into the compartments (7c), so as to establish a fluidic connection between battery modules (2) and fluid-conducting support elements (7a) when inserting the battery modules (2), wherein the fluidic connector structures (17) of the battery modules (2) in the region of the compartments (7c) in the insertion direction (P1, P2) are co-aligned with at least partially complementary connector structures (18) of the battery modules (2) to establish a fluidic connection between battery modules (2) and the fluid-conducting support elements (7a) when inserting the battery modules (2), the complementary connector structures (18) of the battery modules (2) engaging in the connector structures (17) of the support structure (7).

18. The battery module assembly (1) as claimed in claim 17, further comprising at least one sealing element (19) disposed on the connector structures (18) of the battery modules (2) for sealing engagement to the connector structures (17) of the support structure (7).
